(19) United States
(12) Patent Application Publication
(10) Pub. No.: US 2025/0178864 A1
(43) Pub. Date: Jun. 5, 2025

(54) ELEVATOR SYSTEM AND OPERATING TERMINAL HAVING GRAPHICAL USER INTERFACE

(71) Applicant: INVENTIO AG, Hergiswil (CH)

(72) Inventor: Dennys TAIANA, Losone (CH)

(21) Appl. No.: 18/840,762

(22) PCT Filed: Feb. 16, 2023
(86) PCT No.: PCT/EP2023/053835

§ 371 Date: Aug. 22, 2024

(30) Foreign Application Priority Data
Mar. 23, 2022 (EP) 22163837.2

(51) Int. Cl. B66B 1/46; G06F 3/01; G06F 3/0482; G06F 3/0484; G06F 3/0488

(52) U.S. Cl. CPC B66B 1/463; B66B 1/468; B66B 2201/103; B66B 2201/4615; B66B 2201/463; G06F 3/011; G06F 3/0482; G06F 3/0484; G06F 3/0488

(57) ABSTRACT

An elevator system includes an elevator controller, an elevator car, and an operating terminal. The operating terminal includes a 3D sensor system and a touch-sensitive screen system to generate a graphical user interface for display on a touch-sensitive screen. The graphical user interface includes predetermined content. The 3D sensor system determines a surface area on the touch-sensitive screen to be touched by a user when selecting displayed content of interest and generates a control signal having at least one indication specifying the surface area when an object is within a predetermined distance from the touch-sensitive screen. The touch-sensitive screen system generates a display region within the graphical user interface in response to the at least one indication, wherein the display region includes an enlargement of content, and wherein the display region is sized to overlap at least a portion of the surface area.

### TECHNICAL FIELD

The disclosure herein relates generally to an elevator system. Exemplary embodiments of the present disclosure relate in particular to an operating terminal and an elevator system having such an operating terminal. Exemplary embodiments of the present disclosure further relate to a method for operating the elevator system having such an operating terminal.

### SUMMARY

In known elevator systems, a user can input an elevator call at an elevator operating terminal, hereinafter referred to as “operating terminal”. An operating terminal can be arranged on a floor of a building to allow the input of a floor call from there. Depending on the control technology used in an elevator system, different types of operating terminals are used. An operating terminal for an elevator system with an upward/downward direction control system only allows the desired direction of travel to be input as a floor call with one button for the upward direction and one button for the downward direction. In such an elevator system, an operating terminal in an elevator car allows a user to input a car call indicating the desired destination floor, for example, by pressing a button associated with the destination floor. An operating terminal for an elevator system with a destination call control enables the input of the desired destination floor as a floor call, for example, by pressing a button of a specific destination floor. It is then usually no longer possible to input a call in the elevator car.

In particular in very high buildings with a correspondingly large number of floors, a high number of buttons with correspondingly high space requirements may be required to enable the input of all possible destination floors. As an alternative to such buttons, a call input terminal is known from EP 0 699 617 B1 that has a reader for an RFID card presented by a user for call input. However, such readers and the management of RFID cards are not suitable for all buildings, e. g., because they require a relatively high effort in terms of cost and management. Another alternative is known from US 2014/0014444, in which an operating terminal arranged on a floor only displays some floors on a display in the form of a row that the user can touch to input a call. If the user swipes over the display at any point, other floors are displayed. Floors that have already been selected are no longer indicated in the list. Although these alternatives disclose certain solutions to the aforementioned problem of the high number of buttons, there is a need for a technology for an operating terminal that can be used in a plurality of buildings and is user-friendly.

One aspect of the present disclosure described herein relates to an elevator system that can have an elevator controller, an elevator car movable under control of the elevator controller between floors of a building, and an operating terminal communicatively coupled to the elevator controller. The operating terminal can have a three-dimensional sensor system and a touch-sensitive screen system configured to generate a graphical user interface for display on a touch-sensitive screen of the touch-sensitive screen system. The graphical user interface can include a predetermined content. The three-dimensional sensor system can be configured to determine a surface area on the touch-sensitive screen to be touched by a user when selecting displayed content of interest, and to generate a control signal including at least one indication specifying the surface area when an object moved by the user is within a predetermined distance from the touch-sensitive screen. The touch-sensitive screen system can be configured to generate a display region within the graphical user interface in response to the at least one indication, wherein the display region can include an enlargement of content related to the surface area and the content of interest. The display region can be sized to overlap at least a portion of the surface area.

Another aspect can relate to an operating terminal for an elevator system having a communication terminal which is configured to communicate with an elevator controller of an elevator system. The operating terminal can include further a central control and processing terminal which is communicatively connected to the communication terminal, a three-dimensional sensor system and a touch-sensitive screen system configured to generate a graphical user interface for display on a touch-sensitive screen of the touch-sensitive screen system. The graphical user interface can include a predetermined content. The three-dimensional sensor system can be configured to determine a surface area on the touch-sensitive screen to be touched by a user when selecting displayed content of interest, and to generate a control signal including at least one indication specifying the surface area when an object moved by the user is within a predetermined distance from the touch-sensitive screen. The touch-sensitive screen system can be configured to generate a display region within the graphical user interface in response to the at least one indication, wherein the display region can include an enlargement of content related to the surface area and the content of interest. The display region can be sized to overlap at least a portion of the surface area.

Another aspect can relate to a method for operating an elevator system having an elevator car, an elevator controller and an operating terminal which is communicatively connected to the elevator controller and arranged for inputting an elevator call. The operating terminal can have a three-dimensional sensor system and a touch-sensitive screen system having a touch-sensitive screen system. The method can include generating, by the touch-sensitive screen system, a graphical user interface for display on a touch-sensitive screen of the touch-sensitive screen system, wherein the graphical user interface includes a predetermined content. The method can further include determining, by the three-dimensional sensor system, a surface area on the touch-sensitive screen to be touched by a user when selecting displayed content of interest, and generating, by the three-dimensional sensor system, a control signal including at least one indication specifying the surface area when an object moved by the user is within a predetermined distance from the touch-sensitive screen. In addition, the method can include generating, by the touch-sensitive screen system, a display region within the graphical user interface in response to the at least one indication. The display region can include an enlargement of content related to the surface area and the content of interest, wherein the display region is sized to overlap at least a portion of the surface area.

The various aspects of the disclosure herein can provide for an operating terminal that determines a surface area a user is about to touch when selecting displayed content of interest and, in response, displays an enlargement of that content. Such an enlargement function may be considered as a zooming function. For example, this means that the operating terminal may initially display a bird's eye view of the content to provide a general overview of the content (e.g., content may be displayed in form of a representation or relatively small letters, numbers, or symbols); upon determining where the user is about to touch (e.g., in which content the user is interested), the operating terminal zooms in and displays the enlargement of the content. Such enlargement of the content, e.g., larger numbers or symbols, can facilitate selecting the content by a user.

Applied to an operating terminal for an elevator system, destination buttons (e.g., for all floors served by the elevator system) may be displayed as relatively small sized and closely spaced apart numbers. It is contemplated that for some users these destination buttons are not user friendly. However, the various aspects of the disclosure herein may improve the user friendliness in that—upon determining the surface area (including destination buttons) the user is about to touch—destination buttons within that surface area may be displayed larger and wider spaced apart. This can reduce, for example, erroneous or double calls when the user slightly misplaces a finger and inadvertently touches the wrong destination button or two neighboring buttons.

In one embodiment, the predetermined content included in the graphical user interface may include identifiers for the floors of the building. The display region may include an enlargement of a selected number of the identifiers as content related to the surface area and the content of interest. The identifiers may be floor numbers (e.g., Arabic numerals) or floor symbols or letters (e.g., “L” or “P” for the building's lobby or parking floors, respectively) assigned to the floors served by the elevator system.

In another embodiment, the predetermined content included in the graphical user interface may include a representation of the building. The display region may include an enlargement of a selected number of floor identifiers, entity identifiers and/or service identifiers as content related to the surface area and the content of interest. One example of such a representation can be a profile of the building. The profile may by a lateral plan or perspective view, wherein details of the building such as selected floors, a range of floors and/or building zones may be indicated. The floor identifiers may include floor numbers or floor symbols or letters. The entity identifiers may include personal names and/or names and logos of companies or businesses, and the service identifiers may include labels, pictograms and/or symbols, e.g., for restaurants, fitness and wellness areas. For example, a user may touch the profile at a general area or at one of the indicated details to zoom in and to cause an enlargement of the identifiers assigned to the general area or detail.

In one embodiment, which may be applicable in connection with one or more of the preceding embodiments, the operating terminal can be configured to generate an elevator call upon the user touching one of the identifiers included in the display region. The elevator call may relate to a destination floor corresponding to the touched identifier. Hence, a user may not only obtain information by zooming in, but may also enter an elevator call to the destination floor. Further, as mentioned herein, the enlargement of the content within the display region can facilitate selecting the content by the user.

In one embodiment, which may be applicable in connection with one or more of the preceding embodiments, the three-dimensional sensor system can include a processor configured to determine a trajectory of the object and to use the trajectory to determine the surface area. Based on that surface area the display region can include an enlargement of the content related to the surface area and the content of interest. For example, the related content can include several floor identifiers, one of which the user may select to enter an elevator call. In this regard, it suffices (e.g., demand for accuracy is relatively low) that the surface area determined by the disclosure described herein can include, e.g., the identifier the user ultimately selects. With low demand for accuracy, processing speed may improve.

In one embodiment, which may be applicable in connection with one or more of the preceding embodiments, the processor of the three-dimensional sensor system can be configured to generate tracking information indicative of the user's movement towards or past the operating terminal. The processor may be further configured to change the operating terminal from a standby mode to an active mode if the tracking information is indicative of an approaching user. Tracking the user may allow determining if the user is walking towards the operating terminal to use it or walks by the operating terminal without using it. In the latter situation, the operating terminal may not have to react and may remain in the standby (inactive) mode with low energy consumption.

In one embodiment, which may be applicable in connection with one or more of the preceding embodiments, the three-dimensional sensor system may include a radar sensor or a Time-of-Flight sensor. Such sensors may be available as compact modules and are, therefore, can be suitable for being built into a housing of an operating device. For protection against, e.g., vandalism, the sensors can be covered by a material of suitable transmittance.

### BRIEF DESCRIPTION OF THE DRAWINGS

Herein, various aspects of the disclosure are explained in more detail by means of exemplary embodiments in connection with the figures. All figures are merely schematic illustrations of methods and terminals or their components according to exemplary embodiments of the disclosure. In particular, distances and size relations are not reproduced to scale in the figures. In the figures, identical elements have identical reference signs. In the drawings:

FIG. 1 shows a schematic illustration of an exemplary elevator system in a building with several floors;

FIG. 2 shows a schematic illustration of exemplary user scenarios;

FIG. 3A-3B show schematic illustrations of user interfaces of an operating terminal used in the elevator system of FIG. 1;

FIG. 4A-4C show schematic illustrations of other user interfaces of an operating terminal used in the elevator system of FIG. 1;

FIG. 5 shows an example of an embodiment of a method for operating of the elevator system's operating terminal; and

FIG. 6 shows a schematic illustration of an operating terminal with exemplary components.

### DETAILED DESCRIPTION

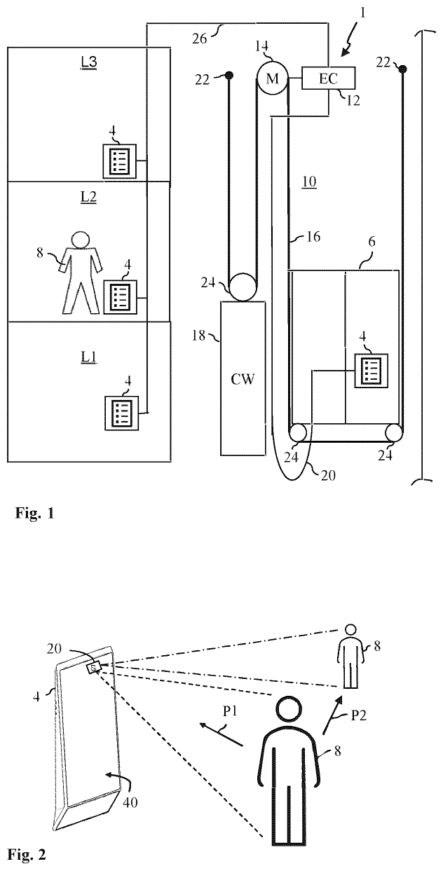

FIG. 1 shows a schematic illustration of an exemplary embodiment of an elevator system 1 in a building; the building can in principle be any type of multilevel building (e.g., residential building, hotel, office building, sports station, etc.), wherein the disclosure described herein may be particularly advantageous in very tall buildings, for example, in buildings with a plurality of floors. Herein, components and functions of the elevator system 1 are explained as far as they seem helpful for an understanding of the disclosure described herein. The building shown in FIG. 1 has a plurality of floors L1, L2, L3 served by the elevator system 1, e.g., a user 8 can be transported from a boarding floor to a destination floor by the elevator system 1 after inputting a call at an operating terminal 4 while at the boarding floor. In the exemplary embodiment shown, the elevator system 1 has an elevator car 6 that is movable along a travel path in the building. For example, the travel path can extend along a vertical elevator shaft 10, without being limited to such a travel path. Herein, embodiments of the disclosure are described with reference to the exemplary elevator system 1 shown in FIG. 1.

The elevator system 1 shown in FIG. 1 also comprises an elevator controller (EC) 12, a drive machine (M) 14, a counterweight 18, a signal transmission system 20 (also referred to as hanging cable), a suspension means 16 (one or more steel ropes or flat belts) and a plurality of deflection pulleys 24. The suspension means 16 has two ends, each end being attached to a fixed point 22 in the elevator shaft 10. Between the fixed points 22, the suspension means 16 partially wraps around the deflection pulley 24 on the counterweight 18, a traction sheave of the drive machine 14 and the deflection pulleys 24 on the elevator car 6. The elevator system 1 shown is thus a traction elevator, wherein further details, such as, for example, guide rails for the elevator car 6 and guide rails for the counterweight 18 are not shown in FIG. 1. The elevator controller 12 is connected to the drive machine 14 and can control it to move the elevator car 6 in the shaft 10. The function of a traction elevator, the components of which and the tasks of an elevator control 12 are generally known to the person skilled in the art. The person skilled in the art will recognize that the disclosure described herein is not limited to use in a traction elevator. The person skilled in the art will also recognize that the elevator system 1 can comprise a plurality of elevator cars 6 or multi-deck cars in one or more elevator shafts 10 or can comprise one or more groups of elevators controlled by a group controller.

In FIG. 1, an operating terminal 4 is arranged on each floor L1, L2, L3 and is coupled to the elevator controller 12 with a communication connection 26. The communication connection 26 may be implemented wired (e.g., by individual lines or a communication bus) and/or wireless. Each of these operating terminals 4 can have, for example, a terminal identifier (also referred to as a terminal ID) by which an operating terminal 4 is identifiable and addressable; for example, the operating terminal 4 can send a call along with its terminal ID to the elevator controller 12 which can confirm the call to the operating terminal 4 identified by the terminal ID. In this case, information about an elevator allocated to serve the call can also be sent.

As shown in FIG. 1, a further operating terminal 4 is arranged in the elevator car 6 and connected to the elevator controller 12 with the signal transmission system 20. The floor-side operating terminal 4 may be referred to as floor terminal and the car-side operating terminal may be referred to as car terminal. For illustration purposes, the operating terminals 4 are shown with the same symbol. The person skilled in the art will recognize that the configurations of the operating terminals 4 depend on the control technology (up/down directional call control technology or destination call control technology) applied in the elevator system 1. For example, when the destination call control technology is used, a floor terminal can allow a user 8 to enter a destination floor, while the car terminal may allow the user 8, e.g., to signal an emergency and/or to affect the closing of the elevator doors. When the up/down directional call control technology is used, a floor terminal can be configured for inputting a desired direction of travel, e.g., it has a button for the upward direction and a button for the downward direction, while the car terminal can allow inputting a destination floor. Embodiments of the disclosure described herein are described with reference to the destination call control technology and operating terminals arranged on the floors L1, L2, L3.

The operating terminal 4 can be arranged at a desired location on a floor L1, L2, L3, e.g., on a building wall or freestanding at a desired location. The location can be, e.g., an anteroom in front of one or more elevator (floor) doors or an entrance to an elevator lobby. While the location may be relatively freely selectable, there can be specifications (e.g. according to a standard (e.g., EN81-70) or of legal nature) in terms of in which height range the operating terminal 4 or a user interface of the operating terminal 4 is to be arranged. This can be to ensure that the operating terminal 4 is located at a height at which the operating terminal 4 or the user interface can be reached by potential users and displayed information can be perceived. For example, while on a floor L1, L2, L3, a user 8 may approach an operating terminal 4 with an intention to use the elevator system 1, while other users 8 may pass by an operating terminal 4 without a present intention to use the elevator system 1. In FIG. 2, an arrow P1 indicates a user 8 walking towards a schematically illustrated operating terminal 4, and an arrow P2 indicates a user 8 walking away from (passing) the operating terminal 4. The skilled person recognizes that the user 8 may in a similar manner walk towards the operating terminal 4 in the elevator car 6.

At least one operating terminal 4 can include a three-dimensional (3D) sensor system 20. The 3D sensor system 20 can be configured to determine, e.g., positional information of the user 8 with respect to the operating terminal 4 when the user 8 is within a detection range of the 3D sensor system 20. The positional information can include, e.g., a distance between the user 8 and the operating terminal 4 and a direction of movement of the user 8. As illustrated in FIG. 2, the determined positional information may allow the operating terminal 4 to distinguish between an approaching user 8 (arrow P1) and a passing user 8 (arrow P2). In such situations, the positional information may change as a function of time, and the 3D sensor system 20 tracks the user 8.

The 3D sensor system 20 can include in one embodiment a 3D radar sensor having an integrated microwave motion sensor. The microwave motion sensor can include antennas (antenna-in-package technology) and built-in detectors for motion and direction of motion, wherein a state machine can enable operation of the sensor without any external microcontroller. Such a sensor is available from, for example, Infineon Technologies AG, Germany. In another embodiment, the 3D sensor system 20 can include a 3D indirect Time-of-Flight (iToF) sensor for use in a small form-factor 3D camera producing a high-definition depth map. Such a sensor is available from, for example, STMicroelectronics, Switzerland/Netherlands. Such sensors have a detection range of several meters, e.g., up to about 5-7 meters.

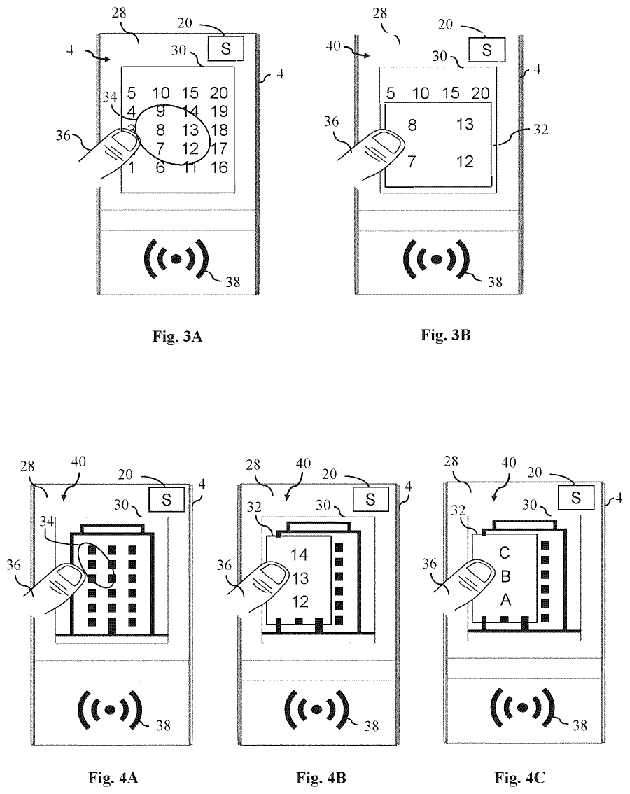

In addition to the 3D sensor system 20, the at least one operating terminal 4 can include a touch-sensitive screen system 40. As shown in FIG. 2, the 3D sensor system 20 and the touch-sensitive screen system 40 can be oriented towards a user-accessible side of the operating terminal 4. The touch-sensitive screen system 40 can be configured to generate a graphical user interface 30 for display on a touch-sensitive screen 28 of the touch-sensitive screen system 40, for example, as shown in FIG. 3A. In FIG. 3A, the touch-sensitive screen system 40 with its graphical user interface 30 is shown above a representation for a recognition device 38 (which is not part of the touch-sensitive screen system 40 and described below). The touch-sensitive screen 28 is hereinafter referred to as “touch screen 28.” The operating mode and principal structure of a touch-sensitive screen system having a touch screen are generally known to the person skilled in the art; the person skilled in the art knows in particular, for example, from the programming and use of smartphones or other electronic terminals having graphical user interfaces, how text, symbols, pictograms, input and output fields, etc. are generated on a touch screen and displayed on the user interface, and how to react when a user touches a certain area of the touch screen for selecting content represented by a symbol, pictogram or field (e.g., for entering a selection or command).

The touch-sensitive screen system 40 can be configured to cause the graphical user interface 30 to display a predetermined content, as described herein with reference to FIG. 3A-FIG. 4C. Corresponding to the building and elevator situation shown in FIG. 1, the graphical user interface 30 according to the embodiment shown in FIG. 3A contains, as predetermined content, a keypad for entering an elevator call. The keypad includes fields arranged, e.g., in form of a (M×N) matrix (e.g., M=5 rows, N=4 columns, with a total of 20 fields). The skilled person recognizes that the arrangement of the fields is not limited to a matrix. Each field displays a number assigned to one the 20 floors of the building. To select content of interest (e.g., one of the 20 floors as a destination floor), a user 8 can touch the corresponding field or number with an object 36 (in FIG. 3A-FIG. 4C the object 36 is a finger; alternatively, the object 36 may be a pen, a stylus or another pointing device).

In the situation shown in FIG. 3A, a surface area 34 about to be touched by the object 36 when selecting the content of interest is shown for illustrative purposes (e.g., covering the fields with numbers 7-9 and 12-13). In response, as shown in FIG. 3B, the graphical user interface 30 displays a display region 32 that includes an enlargement of the content related to the surface area 34 and its content of interest; e.g., the display region 32 includes the (now enlarged) fields with the numbers 7, 8, 12 and 13 from which the user 8 can select. The display region 32 is sized to overlap at least a portion of the surface area 34; the content of interest, therefore, stands out and is particularly noticeable by the user 8 which facilitates its selection.

Again, corresponding to the building and elevator situation shown in FIG. 1, the graphical user interface 30 according to the embodiment shown in FIG. 4A contains as predetermined content a representation of the building. One example of such a representation is a profile of the building. The profile may by a lateral plan or perspective view, wherein details of the building such as selected floors, a range of floors and/or building zones may be indicated. The illustrated surface area 34 about to be touched by the object 36 when selecting the content of interest covers several floors. In response, as shown in FIG. 4B, the graphical user interface 30 displays a display region 32 that includes an enlargement of the content related to the surface area 34 and its content of interest; e.g., the display region 32 includes the floors covered by the surface area 34, e.g., the floors 12, 13, 14. In another embodiment, as shown in FIG. 4C, the display region 32 can also include an enlargement of the content related to the surface area 34 and its content of interest, but the display region 32 can include identifiers of entities located on floors covered by the surface area 34, for example, names (A, B, C) of private persons and/or legal entities (e.g., enterprises, businesses), wherein for a legal entity its logo may be displayed, as well. In some embodiments, the identifiers may include labels, pictograms and/or symbols to represent services available at certain floors, e.g., restaurants, fitness and wellness areas. In the embodiments shown in FIG. 4B and FIG. 4C, the display region 32 is sized to overlap at least a portion of the surface area 34 providing the benefits mentioned above with respect to FIG. 3B.

Further functional and structural details of the operating terminal 4 are described herein with reference to FIG. 6.

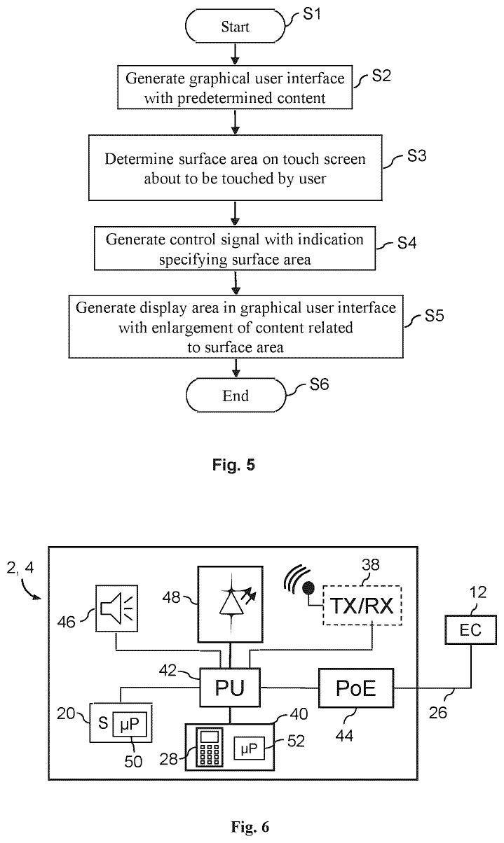

With the understanding of the principal system components of the elevator system 1 and its functionalities described herein, a description of an exemplary method for operating an operating terminal 4 arranged in the elevator system 1 is provided herein with reference to FIG. 5. The exemplary description is provided with reference to an operating terminal 4 arranged on one of the floors L1, L2, L3. The elevator system 1 may be in operation (e.g., not in standby mode). The method described with reference to FIG. 5 starts in a step S1 and ends in a step S6. The person skilled in the art will recognize that the division into the steps shown is exemplary, and that one or more of these steps can be divided into one or more sub-steps, or that several of the steps can be combined into one step.

The illustrated method considers a situation in which a user 8 is present on one of the floors L1, L2, L3 and moves towards one of the operating terminals 4 arranged on that floor L1, L2, L3. The 3D sensor system 20 of that operating terminal 4 may detect the user's presence and moving direction. If the operating terminal 4 is in an inactive or standby mode (e.g., the touch screen 28 is not illuminated), detecting the approaching user 8 may cause the operating terminal 4 to change from the standby mode to an active mode (e.g., the touch screen 28 is then illuminated).

Referring to a step S2, the operating terminal 4 is in the active mode and a graphical user interface 30 for display on the touch screen 28 of the touch-sensitive screen system 40 is generated. In one embodiment, the touch-sensitive screen system 40 can be configured to generate the graphical user interface 30. The graphical user interface 30 can include predetermined content, which may be the number matrix shown in FIG. 3A or the building representation shown in FIG. 4A, for example. A processor 52 shown in FIG. 6 can be programed to operate the touch screen 28 to generate the graphical user interface 30 including the predetermined content. The predetermined content may be stored in an electronic storage device of the operating terminal 4.

In a step S3, a surface area 34 on the touch-sensitive screen 28 about to be touched by the user 8 when selecting displayed content of interest can be determined. In one embodiment, the 3D sensor system 20 can be configured to determine that surface area 34 due to its tracking capability, as mentioned herein. Based on the spatial relationship between the 3D sensor system 20 and the graphical user interface 30, a processor 50 (FIG. 6) of the 3D sensor system 20 can calculate a trajectory of the object 36 that is predicted to end at the surface area 34.

In a step S4, a control signal can be generated that includes at least one indication specifying the surface area 34 when the object 36 moved by the user 8 is within a predetermined distance from the touch-sensitive screen 28. The at least one indication may specify the predicted end of the trajectory and (e.g., because of an uncertainty of the trajectory's end) a predetermined area around that end, e.g., it may be one or more fields of the matrix shown in FIG. 3A or one or more sets of x-y coordinates of the graphical user interface 30.

In a step S5, a display region 32 within the graphical user interface 28 can be generated in response to the at least one indication. The display region 32 can include an enlargement of content related to the surface area 34 and the content of interest, wherein the display region 32 can be sized to overlap at least a portion of the surface area 34. The touch-sensitive screen system 40 can be configured to generate the display region 32 which provides for a zoom function, as illustrated in FIG. 3B, FIG. 4B and FIG. 4C, for example. That is, by directing the object 36 (finger) in the general direction of the content of interest (e.g., numbers between 7 and 13 in FIG. 3A, or upper floors in FIG. 4A) the user 8 can zoom in to obtain the enlargement of the content of interest. In the display region 32 the numbers, for example, may not only be enlarged but further spaced apart from each other, which can facilitate touching the intended number (floor) by the user 8. This may reduce, for example, erroneous or double calls when the user 8 slightly misplaces the finger and unintentionally touches the wrong number or two numbers. The method ends in the step S6.

FIG. 6 shows a schematic representation of an example of an operating terminal 4 which may be arranged in the elevator system 1 according to FIG. 1 on a floor L1, L2, L3. Depending on the control technology used in the elevator system 1, the operating terminal 4 may be arranged in the elevator car 6. The operating terminal 4 can be communicatively connected to the elevator controller 12 via the communication network 26 (or the hanging cable 20 when arranged in the elevator car 6). The operating terminal 4 can include in one embodiment a housing for positioning the operating terminal 4 on a building wall (or a wall of the elevator car 6) or on a pedestal that stands on a building floor. A person skilled in the art recognizes that such a housing may not be necessary if the operating terminal 4 is installed completely or in part in a building wall or in a door frame of a floor-side elevator door.

In the embodiment shown, the operating terminal 4 includes: the touch-sensitive screen system 40 comprising the touch screen 28, the 3D sensor system 20, a communication terminal 44 (PoE); and an illumination device 48. In one embodiment, the touch screen 28 can have a transparent glass cover which closes the housing externally and/or on a user side. The outer surface of the glass cover can be a touch surface which the user 8 may touch, for example, when inputting a call. A person skilled in the art recognizes that the glass cover can have a planar or curved glass plate. An electroacoustic transducer 46 (e.g., a loudspeaker) can be provided in order to generate acoustic feedback (voice announcement), e.g., when touching the touch screen 28.

The touch-sensitive screen system 40 can comprise a processor 52. The processor 52 can be connected to a central control and processing unit 42 (PU) and can communicate, for example, with the elevator controller 12 and can detect a signal when a user 8 touches the touch surface using a finger (object 36). The processor 52 can be configured to cause the graphical user interface 30 to display of the predetermined content and the display region 32.

The 3D sensor system 20 can include a processor 50 connected to the central control and processing unit 42 (PU). The processor 50 performs the mentioned tracking of the user 8 and the object 36 to determine the user's presence and directional movement. Further, the processor 50 can be configured to determine the surface area 34 on the touch screen 28 about to be touched by the user 8 when selecting displayed content of interest, and to generate a control signal including at least one indication specifying the surface area 34 when the object 36 moved by the user 8 is within a predetermined distance from the touch screen 28.

The illumination device 48 may be used to illuminate the touch screen 28. In a manner controlled by the central control and processing unit 42, the illumination device 48 can light up the graphical user interface 30 such that the displayed content can be perceived by the user 8, in particular in poor lighting conditions. The illumination device 48 can also illuminate the graphical user interface 30 or individual fields or areas with colored light in order to confirm the input of an elevator call to the user 8. In one embodiment, the illumination device 48 can comprise one or more LED light sources.

Depending on the building and/or the elevator system 1, the operating terminal 4 may include the recognition device 38 to receive a credential of the user 8. The recognition device 38 can be provided in the building, for example, if users first have to identify themself as authorized before the operating terminal 4 can be enabled for the call input or a call is registered. The credentials can, for example, be in the form of a physical key, a manually input password (e.g., a PIN code), a biometric feature (e.g., fingerprint, iris pattern, speech/voice characteristics) or an access code captured from a magnetic card, chip card or RFID card or from an electronic terminal (NFC-, Bluetooth-or cellular network-based). Users 8 can present the credentials when they want to input the elevator calls. The recognition device 38 can be configured in accordance with the credentials provided in the elevator system 1. This means that the recognition device 38 can have, for example, a key cylinder, a terminal for capturing a biometric feature, a terminal for capturing an optical code, a reader for a magnetic stripe card or a chip card, a keypad or a touch-sensitive screen for manually inputting a password, or a transmitting and receiving terminal for radio signals. The skilled person recognizes that the operating terminal 4 may be configured for more than one of these alternatives.

The credentials captured by the recognition device 38 can be forwarded to the elevator controller 12, which can carry out or initiate the authorization check, for example, by checking whether the credential captured is assigned to an authorized user 8 in a database.

The check can be carried out, for example, by an access control function of the elevator system 1 or of an (separate) access control system. If the user 8 is authorized to access, the elevator operating terminal 6 can be enabled, or an entered elevator call can be registered by the elevator controller 12.

In the embodiment shown in FIG. 6, the recognition device 38 is configured for transmitting and receiving radio signals (TX/RX). The recognition device 38 can include an RFID reader or a radio module which communicates with a portable communication terminal (e.g., mobile radio/mobile phone, smartphone, tablet PC) of a user 8. As an alternative, a reader for an optical code presented by the user 8 (for example a barcode, QR code or color code) can be provided.

The communication network 26 can connect the elevator operating terminals 4 to the elevator controller 12 and thus can make communication possible between the elevator controller 12 and the elevator operating terminals 4. For this communication, the elevator operating terminals 4 and the elevator controller 12 can be directly or indirectly connected to the communication network 26. The communication network 26 can comprise a communication bus system, individual data lines, a wireless communications system or a combination thereof. Depending on the implementation of the communication network 26, individual addresses and/or identifiers can be allocated to the elevator controller 12 and each elevator operating terminal 6, such that, for example, the elevator controller 12 can send a message to a desired elevator operating terminal 4 in a targeted manner. Communication can take place in accordance with a protocol for wired or wireless communication, for example the Ethernet protocol. As mentioned, in one embodiment the elevator operating terminals 4 are supplied with electrical energy via the communication network 26 (PoE).

In one embodiment, the central control and processing unit 42 can be configured to put the operating terminal 4 into an inactive state in order to reduce its consumption of electrical energy. In this standby or energy-saving state, the control and processing terminal 43 can switch off the illumination terminal 54, for example; the user interface 34 then appears in one embodiment as a dark (black) area. The switch-off can take place if no user 8 has been at or in the vicinity of the elevator operating terminal 6 for a set period of time. For this purpose, a dedicated sensor (not shown in FIG. 4) or the 3D sensor system 20 can be used to detect the presence and/or a movement of a user 8. The dedicated sensor can be provided in the elevator operating terminal 6 and can include a motion sensor that operates according to one of known functional principles, e.g., actively using electromagnetic waves (RF, microwaves or Doppler radar), using ultrasound (ultrasonic motion detector) or passively using infrared radiation (PIR sensor, pyroelectric infrared sensor) from the environment. If the elevator operating terminal 4 is in the energy-saving state and the presence of a user 8 is detected, the central control and processing terminal 43 can switch the elevator operating terminal 6 to an active state.

In one exemplary embodiment, the signal transmission system 20 can comprise an electric cable provided, for example, in a traction elevator for transmitting electrical energy and electrical signals and extending between the elevator car 6 and a fixed point to which the elevator controller 12 is coupled. For this purpose, the electrical cable may have electrical power and signal lines. For example, the electrical cable can supply electrical energy to the elevator car 6 and transmit signals (e.g., load, status, and/or car call information) to and from the elevator car 6. The electrical cable is also known to the person skilled in the art as a (flat) traveling cable and is therefore referred to as such herein. Terminals that couple the traveling cable, on the one hand, to the elevator controller 12 and its power/voltage supply and, on the other hand, to the elevator car 6 and its electrical and electronic components are therefore known to the person skilled in the art. The person skilled in the art will recognize that the car terminal 2 can be electrically coupled to the traveling cable.

1.-15. (canceled)

16. An elevator system, comprising:
an elevator car configured to move between floors of a building;
an elevator controller configured to control the elevator car to move between the floors of the building; and
an operating terminal communicatively coupled to the elevator controller,
wherein the operating terminal comprises a three-dimensional sensor system and a touch-sensitive screen system configured to generate a graphical user interface for display on a touch-sensitive screen of the touch-sensitive screen system, the graphical user interface comprising predetermined content,
wherein the three-dimensional sensor system is configured to determine a surface area on the touch-sensitive screen to be touched by a user when selecting displayed content of interest, and to generate a control signal comprising at least one indication specifying the surface area when an object moved by the user is within a predetermined distance from the touch-sensitive screen; and
wherein the touch-sensitive screen system is configured to generate a display region within the graphical user interface in response to the at least one indication, wherein the display region includes an enlargement of content related to the surface area and the displayed content of interest, and wherein the display region is sized to overlap at least a portion of the surface area.

17. The elevator system of claim 16, wherein the three-dimensional sensor system comprises a processor configured to determine a trajectory of the object and to use the trajectory to determine the surface area.

18. The elevator system of claim 17, wherein the processor of the three-dimensional sensor system is further configured to generate tracking information indicative of a movement of the user towards or past the operating terminal, wherein the processor is further configured to change the operating terminal from a standby mode to an active mode if the tracking information is indicative of an approaching user.

19. The elevator system according to claim 16, wherein the three-dimensional sensor system comprises a radar sensor or a Time-of-Flight sensor.

20. The elevator system according to claim 17, wherein the three-dimensional sensor system comprises a radar sensor or a Time-of-Flight sensor.

21. The elevator system of claim 16, wherein the predetermined content comprises identifiers for the floors of the building, wherein the display region comprises an enlargement of a selected number of the identifiers as content related to the surface area and the displayed content of interest.

22. The elevator system of claim 17, wherein the predetermined content comprises identifiers for the floors of the building, wherein the display region comprises an enlargement of a selected number of the identifiers as content related to the surface area and the displayed content of interest.

23. The elevator system of claim 16, wherein the predetermined content comprises a representation of the building, wherein the display region comprises an enlargement of at least one of a selected number of floor identifiers, entity identifiers or service identifiers as content related to the surface area and the displayed content of interest.

24. The elevator system of claim 17, wherein the predetermined content comprises a representation of the building, wherein the display region comprises an enlargement of at least one of a selected number of floor identifiers, entity identifiers or service identifiers as content related to the surface area and the displayed content of interest.

25. The elevator system of claim 21, wherein the operating terminal is configured to generate an elevator call upon the user touching one of the identifiers, wherein the elevator call relates to a destination floor corresponding to the identifier touched.

26. The elevator system of claim 23, wherein the operating terminal is configured to generate an elevator call upon the user touching one of the identifiers, wherein the elevator call relates to a destination floor corresponding to the identifier touched.

27. An operating terminal, comprising:
a communication terminal which is configured to communicate with an elevator controller of an elevator system;
a central control and processing terminal which is communicatively connected to the communication terminal;
a three-dimensional sensor system; and
a touch-sensitive screen system configured to generate a graphical user interface for display on a touch-sensitive screen of the touch-sensitive screen system, the graphical user interface comprising predetermined content,
wherein the three-dimensional sensor system is configured to determine a surface area on the touch-sensitive screen to be touched by a user when selecting displayed content of interest, and to generate a control signal comprising at least one indication specifying the surface area when an object moved by the user is within a predetermined distance from the touch-sensitive screen; and
wherein the touch-sensitive screen system is configured to generate a display region within the graphical user interface in response to the at least one indication, wherein the display region includes an enlargement of content related to the surface area and the displayed content of interest, and wherein the display region is sized to overlap at least a portion of the surface area.

28. The operating terminal of claim 27, wherein the three-dimensional sensor system comprises a processor configured to determine a trajectory of the object and to use the trajectory to determine the surface area.

29. The operating terminal of claim 28, wherein the processor of the three-dimensional sensor system is further configured to generate tracking information indicative of a movement of the user towards or past the operating terminal, wherein the processor is further configured to change the operating terminal from a standby mode to an active mode if the tracking information is indicative of an approaching user.

30. The operating terminal of claim 27, wherein the three-dimensional sensor system comprises a radar sensor or a time-of-flight sensor.

31. The operating terminal of claim 28, wherein the three-dimensional sensor system comprises a radar sensor or a time-of-flight sensor.

32. The operating terminal one of claim 27, wherein the predetermined content comprises identifiers for the floors of the building, wherein the display region comprises an enlargement of a selected number of the identifiers as content related to the surface area and the displayed content of interest, or wherein the predetermined content comprises a representation of the building, wherein the display region comprises an enlargement of at least one of a selected number of floor identifiers, entity identifiers or service identifiers as content related to the surface area and the displayed content of interest.

33. The operating terminal of claim 32, wherein the operating terminal is configured to generate an elevator call upon the user touching one of the identifiers, wherein the elevator call relates to a destination floor corresponding to the identifier touched.

34. A method for operating an elevator system comprising an elevator car, an elevator controller and elevator operating terminals which are communicatively connected to the elevator controller and are configured for inputting an elevator call, wherein an elevator operating terminal comprises a three-dimensional sensor system and a touch-sensitive screen system comprising a touch-sensitive screen, wherein the method comprises:
generating, by the touch-sensitive screen system, a graphical user interface for display on the touch-sensitive screen of the touch-sensitive screen system, the graphical user interface comprising predetermined content;
determining, by the three-dimensional sensor system, a surface area on the touch-sensitive screen to be touched by a user when selecting displayed content of interest;
generating, by the three-dimensional sensor system, a control signal comprising at least one indication specifying the surface area when an object moved by the user is within a predetermined distance from the touch-sensitive screen; and
generating, by the touch-sensitive screen system, a display region within the graphical user interface in response to the at least one indication, wherein the display region comprises an enlargement of content related to the surface area and the content of interest, and wherein the display region is sized to overlap at least a portion of the surface area.

35. The method of claim 34, wherein the predetermined content included in the graphical user interface comprises identifiers for the floors of the building, wherein the display region comprises an enlargement of a selected number of the identifiers as content related to the surface area and the content of interest, or wherein the predetermined content included in the graphical user interface comprises a representation of the building, wherein the display region comprises an enlargement of at least one of a selected number of floor identifiers, entity identifiers or service identifiers as content related to the surface area and the displayed content of interest, wherein the method further comprises generating, by the operating terminal, an elevator call upon the user touching one of the identifiers, wherein the elevator call relates to a destination floor corresponding to the identifier touched.
